(19) United States
(12) Patent Application Publication
(10) Pub. No.: US 2006/0183660 A1
(43) Pub. Date: Aug. 17, 2006

(54) Solid laundry detergent composition

(75) Inventors: Anthony Dovey, Northumberland (GB); Mark Allen Smerznak, Whitley Bay (GB); Lourdes Marina Ramirez Hernandez, Wallsend (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/351,753

(22) Filed: Feb. 10, 2006

(30) Foreign Application Priority Data
Feb. 11, 2005 (EP) 05250781.1

(51) Int. Cl. C11D 17/00

(52) U.S. Cl. 510/447

(57) ABSTRACT

The present invention relates to a solid laundry detergent composition comprising: (a) from 0.1 wt % to 5 wt %, by weight of the composition, of a branched alkyl alkoxylated sulphate surfactant having an average degree of alkoxylation of from 1 to 7; (b) from 0.1 wt % to 5 wt % by weight of the composition, of a linear alkyl alkoxylated sulphate surfactant having an average degree of alkoxylation of from 1 to 7; (c) from 0.1 wt % to 35 wt % linear alkyl benzene sulphonate surfactant; (d) from 0 wt % to 5 wt % zeolite builder; (e) from 0 wt % to 5 wt % phosphate builder; and (f) optionally, adjunct components; wherein the weight ratio of the branched alkyl alkoxylated sulphate surfactant and the linear alkyl alkoxylated sulphate surfactant is in the range of from 0.2:1 to 4:1.

### FIELD OF THE INVENTION

The present invention relates to solid laundry detergent compositions. In particular, the present invention relates to a laundry detergent composition in granular or other solid form such as a tablet, having a good fabric cleaning performance together with good product dispensing and dissolution characteristics.

### BACKGROUND OF THE INVENTION

Solid laundry detergent compositions need to have a very good fabric-cleaning performance against a wide variety of soil types. Solid laundry detergents also need to have very good dispensing and dissolution profiles. However, a dichotomy may exist in that some reformulations of the solid laundry detergent composition to improve its fabric-cleaning performance may negatively impact its dispensing and dissolution profiles, and vice versa. It is very difficult to improve the cleaning performance, dispensing profile and dissolution profile of a solid laundry detergent composition at the same time.

Anionic detersive surfactants are incorporated into granular laundry detergent compositions in order to provide a good fabric-cleaning benefit. For example, GB1408969, GB1408970, U.S. Pat. No. 4,487,710, U.S. Pat. No. 5,663,136 and WO2004/041982 all relate to compositions comprising anionic detersive surfactants. However, the anionic detersive surfactant is capable of complexing with free cations, such as calcium and magnesium cations, that are present in the wash liquor in such a manner as to cause the anionic detersive surfactant to precipitate out of solution, which leads to a reduction in the anionic detersive surfactant activity. In extreme cases, these water-insoluble complexes may deposit onto the fabric resulting in poor whiteness maintenance and poor fabric integrity benefits. This is especially problematic when the laundry detergent composition is used in hard-water washing conditions when there is a high concentration of calcium cations.

The anionic detersive surfactant's tendency to complex with free cations in the wash liquor in such a manner as to precipitate out of solution is mitigated by the presence of builders, such as zeolite builders and phosphate builders, which have a high binding constant with cations such as calcium and magnesium cations. These builders sequester free calcium and magnesium cations and reduce the formation of these undesirable complexes. However, zeolite builders are water-insoluble and their incorporation in laundry detergent compositions leads to poor dissolution of the laundry detergent composition and can also lead to undesirable residues being deposited on the fabric. In addition, detergent compositions that comprise high levels of zeolite builder form undesirable cloudy wash liquors upon contact with water. Whilst phosphate builders allegedly do not have favourable environmental profiles and their use in laundry detergent compositions is becoming less common; for example, due to phosphate legislation in many countries.

Detergent compositions comprising alkyl benzene sulphonate and alkyl ethoxylated sulphate detersive surfactants are described in GB1408969, GB1408970, U.S. Pat. No. 4,487,710 and U.S. Pat. No. 5,663,136. A detergent composition comprising an anionic detersive surfactant and a non-ionic detersive surfactant that allegedly gives enhanced stain removal at a wide range of water-hardness is described in WO2004/041982. A combination of a granular detergent and a packaging system having a low moisture vapour transfer rate is described in EP634484.

There remains a need for a solid laundry detergent composition comprising an anionic detersive surfactant having a good fabric-cleaning performance, especially a good greasy stain cleaning performance, good whiteness maintenance and very good dispensing and dissolution profiles.

### SUMMARY OF THE INVENTION

The Inventors have found that an alkyl benzene sulphonate surfactant in combination with a branched and linear alkyl alkoxylated sulphate surfactant, is a surfactant system that provides a good fabric-cleaning performance and very good dispensing and dissolution profiles when it is incorporated into a solid laundry detergent composition comprising nil, or low levels of, zeolite builder and phosphate builder.

The present invention provides a solid laundry detergent composition comprising: (a) from 0.1 wt % to 5 wt %, by weight of the composition, of a branched alkyl alkoxylated sulphate surfactant; (b) from 0.1 wt % to 5 wt % by weight of the composition, of a linear alkyl alkoxylated sulphate surfactant; (c) from 0.1 wt % to 35 wt % linear alkyl benzene sulphonate surfactant; (d) from 0 wt % to 5 wt % zeolite builder; (e) from 0 wt % to 5 wt % phosphate builder; and (f) optionally, adjunct components; wherein the weight ratio of the branched alkyl alkoxylated sulphate surfactant and the linear alkyl alkoxylated sulphate surfactant is in the range of from 0.2:1 to 4:1.

### DETAILED DESCRIPTION OF THE INVENTION

Branched Alkyl Alkoxylated Sulphate Surfactant

The composition comprises from 0.1 wt % to 5 wt %, preferably from 0.5 wt %, or from 1 wt %, and preferably to 3 wt %, or to 2 wt % by weight of the composition, of a branched alkyl alkoxylated sulphate surfactant. The branched alkyl alkoxylated sulphate surfactant preferably has an average degree of alkoxylation of from 1 to 7, preferably from 2, or from 3, and preferably to 5 or to 3. Preferably, branched alkyl alkoxylated sulphate surfactant has an average degree of alkoxylation of 3. The branched alkyl alkoxylated sulphate surfactant is typically branched with a C₁-C₃ alkyl moiety, preferably a methyl, or preferably an ethyl moiety. Preferably, the branched alkyl alkoxylated sulphate surfactant is a C₈-C₁₈, preferably C₁₂-C₁₅, alkyl ethoxylated sulphate surfactant that is branched with a C₁-C₃ alkyl moiety.

The branched alkyl alkoxylated sulphate surfactant preferably has an alkyl chain length distribution such that (a) less than 1.2 wt % by weight of the alkyl chains, are alkyl chains having a chain length of less than 12 carbon atoms; (b) from 0 wt % to 30 wt %, preferably 5 wt % to 20 wt % by weight of the alkyl chains, are alkyl chains having a chain length of 12 carbon atoms; (c) from 10 wt % to 60 wt %, preferably from 40 wt % to 50 wt % by weight of the alkyl chains, are alkyl chains having a chain length of 14 carbon atoms; and (d) less than 4 wt % by weight of the alkyl chains, are alkyl chains having a chain length of greater than 15 carbon atoms.

Linear Alkyl Alkoxylated Sulphate Surfactant

The composition comprises from 0.1 wt % to 5 wt %, preferably from 0.5 wt %, or from 1 wt %, and preferably to 3 wt %, or to 2 wt % by weight of the composition, of a linear alkyl alkoxylated sulphate surfactant. The linear alkyl alkoxylated sulphate surfactant preferably has an average degree of alkoxylation of from 1 to 7, preferably from 2, or from 3, and preferably to 5 or to 3. Preferably, linear alkyl alkoxylated sulphate surfactant has an average degree of alkoxylation of 3. Preferably, the linear alkyl alkoxylated sulphate surfactant is a linear C₈-C₁₈, more preferably C₁₂-C₁₅, alkyl ethoxylated sulphate surfactant.

Preferably, the linear alkyl alkoxylated sulphate surfactant has an alkyl chain length distribution such that: (a) less than 1.2 wt % by weight of the alkyl chains, are alkyl chains having a chain length of less than 12 carbon atoms; (b) from 0 wt % to 30 wt %, preferably from 5 wt % to 20 wt % by weight of the alkyl chains, are alkyl chains having a chain length of 12 carbon atoms; (c) from 10 wt % to 60 wt %, preferably from 40 wt % to 50 wt % by weight of the alkyl chains, are alkyl chains having a chain length of 14 carbon atoms; and (d) less than 4 wt % by weight of the alkyl chains, are alkyl chains having a chain length of greater than 15 carbon atoms.

Linear Alkyl Benzene Sulphonate Surfactant

The composition comprises from 0.1 wt % to 35 wt %, preferably from 5 wt %, or from 10 wt %, and preferably to 30 wt %, or to 25 wt %, or to 20 wt % linear alkyl benzene sulphonate. The linear alkyl benzene sulphonate may be substituted or unsubstituted. Preferably, the linear alkyl benzene sulphonate is a linear C₈-C₁₈, C₁₁-C₁₃ alkyl benzene sulphonate.

Laundry Detergent Composition

The solid laundry detergent composition comprises (a) from 0.1 wt % to 5 wt %, by weight of the composition, of a branched alkyl alkoxylated sulphate surfactant; (b) from 0.1. wt % to 5 wt % by weight of the composition, of a linear alkyl alkoxylated sulphate surfactant; (c) from 0.1 wt % to 35 wt % linear alkyl benzene sulphonate surfactant; (d) from 0 wt % to 5 wt % zeolite builder; (e) from 0 wt % to 5 wt % phosphate builder; and (f) optionally, adjunct components; wherein the weight ratio of the branched alkyl alkoxylated sulphate surfactant and the linear alkyl alkoxylated sulphate surfactant is in the range of from 0.2:1 to 4:1, preferably from 0.4:1 to 4:1.

The weight ratio of the branched alkyl alkoxylated sulphate surfactant to the linear alkyl alkoxylated sulphate surfactant is in the range of from 0.2:1 to 4:1, preferably from 0.4:1 to 4:1, even more preferably from 0.6:1, or from 0.8:1, or even from 1:1, and preferably to 3:1, or 2:1, or even to 1.5:1. A suitable commercial supply of the branched and linear alkoxylated sulphate surfactants may be a surfactant mixture that comprises both the branched alkyl alkoxylated sulphate surfactant and the linear alkyl alkoxylated sulphate surfactant; this surfactant mixture may in paste form.

Preferably, the weight ratio of the linear alkyl benzene sulphonate to the total amount of linear and branched alkyl alkoxylated sulphate surfactants is in the range of from 1:1 to 20:1, preferably from 2.3:1 to 10:1.

The composition comprises from 0 wt % to 5 wt %, preferably to 4 wt %, or to 3 wt %, or to 2 wt %, or even to 1 wt % zeolite builder. Preferably, the composition is substantially free of zeolite builder. By substantially free of zeolite builder, it is typically meant that no zeolite builder is deliberately incorporated into the composition. Typical zeolite builders are zeolite A, zeolite P and zeolite MAP.

The composition comprises from 0 wt % to 5 wt %, preferably to 4 wt %, or to 3 wt %, or to 2 wt %, or even to 1 wt % phosphate builder. Preferably, the composition is substantially free of phosphate builder. By substantially free of phosphate builder, it is typically meant that no phosphate builder is deliberately incorporated into the composition. A typical phosphate builder is sodium tri-polyphosphate.

Preferably, the branched alkyl alkoxylated sulphate surfactant, the linear alkyl alkoxylated sulphate surfactant and the linear alkyl benzene sulphonate surfactant are in the form of a co-particulate admix; typically this means that the alkyl alkoxylated sulphate surfactant, the linear alkyl alkoxylated sulphate surfactant and the linear alkyl benzene sulphonate surfactant are present in the same particle in the composition. The co-particulate admix, or particle, can be in the form of an agglomerate, an extrudate, a flake, a needle, a noodle, a spray-dried particle. Preferably the co-particulate admix, or particle, is in the form of an agglomerate. Preferably the co-particulate admix, or particle, has a particle size distribution such that no more than 10 wt % by weight of the co-particulate admix, or particle, has a particle size greater than 850 micrometers, and no more than 10 wt % by weight of the co-particulate admix, or particle, has a particle size less than 250 micrometers. The co-particulate admix preferably has a bulk density of from 450 g/l to 1,500 g/l, more preferably from 800 g/l to 1,200 g/l.

The composition can be in granular or other solid form, such as a tablet. Preferably the composition is in particulate form, more preferably in the form of free-flowing particles.

Preferably, the composition has a particle size distribution such that no more than 10 wt % by weight of the composition, has a particle size greater than 850 micrometers, and no more than 10 wt % by weight of the composition, has a particle size less than 250 micrometers.

Adjunct Components

The composition optionally comprises adjunct components. The adjunct components are typically selected from the group consisting of other anionic surfactants, cationic surfactants, non-ionic surfactants, zwitterionic surfactants, other builders, polymeric co-builders such as polymeric polycarboxylates, bleach, hydrotropes, chelants, enzymes, anti-redeposition polymers, soil-release polymers, polymeric soil-dispersing and/or soil-suspending agents, dye-transfer inhibitors, fabric-integrity agents, fluorescent whitening agents, suds suppressors, fabric-softeners, flocculants, cationic fabric-softening components, perfumes and combinations thereof.

A suitable adjunct component may be an anionic surfactant other than the alkyl alkoxylated sulphate surfactant, the linear alkyl alkoxylated sulphate surfactant and the linear alkyl benzene sulphonate surfactant. Suitable other anionic surfactants are branched or linear C₈-C₁₈ alkyl sulphate surfactants. An especially suitable other anionic surfactants are methyl branched C₈-C₁₈ alkyl sulphate surfactants.

A suitable adjunct component is a polymeric polycarboxylate. Suitable polymeric polycarboxylates are co-polymers of maleic acid and acrylic acid, typically having a weight average molecular weight of from 5,000 Da to 10,000 Da, or from 50,000 Da to 90,000 Da. Preferably the molar ratio of maleic acid to acrylic acid is in the range of from 0.25:1 to 0.35:1, or from 1:1 to 0.5:1.

The composition preferably comprises a carbonate source, preferably sodium carbonate and/or sodium bicarbonate. The composition preferably comprises sodium sulphate. Preferably, the weight ratio of the sodium carbonate to sodium sulphate, if present, is in the range of from 0.1:1 to 10:1, more preferably from 0.2, or from 0.3, or from 0.4, and more preferably to 5:1, or to 2:1, or to 1:1 or to 0.8:1, or to 0.6:1.

The composition preferably comprises a hydrotrope. Suitable hydrotropes include sodium cumene sulphate, sodium toluene sulphate, sodium xylene sulphate, tallow alkyl ethoxylate having an average degree of ethoxylation of from 50 to 100.

### EXAMPLES

### Example 1

1.1 Anionic Surfactant Agglomerate

| Ingredient | Amount |
|---|---|
| C₁₁-C₁₃ linear alkyl benzene sulphonate (LAS) | 20 wt % |
| C₁-C₃ branched C₁₂-C₁₅ alkyl ethoxylated sulphate | 1.2 wt % |
| having an average degree of ethoxylation of 3 | |
| (branched AE₃S) | |
| 1.2 wt % C₁₂-C₁₅ linear alkyl ethoxylated sulphate | 1.2 wt % |
| having an average degree of ethoxylation of 3 (linear AE₃S) | |
| Co-polymer of maleic acid and acrylic acid | 5.5 wt % |
| having a weight average molecular weight | |
| of from 50,000 Da to 90,000 Da, | |
| and a molar ratio of maleic acid to acrylic acid | |
| of from 0.25 to 0.35 (co-polymer) | |
| Tallow alkyl ethoxylated alcohol | 3 wt % |
| having an average degree of ethoxylation of 80 (TAE₈₀) | |
| Sodium sulphate | 40 wt % |
| Sodium carbonate | 20 wt % |
| Water and miscellaneous | 9.1 wt % |

1.2. Agglomeration Process

The above-described anionic surfactant agglomerate (described in example 1.1) is prepared by the following process:

The TAE80, co-polymer and aqueous anionic surfactant paste comprising the LAS, branched AE3S and linear AE3S are introduced into a twin screw extruder and extruded into a Lodige CB mixer. Dry material comprising the sodium sulphate and sodium carbonate is introduced into the Lodige CB mixer and mixed with the TAE80, co-polymer and anionic surfactant paste to form a mixture. The mixture is then transferred into a Lodige KM mixer, water is sprayed into the KM and the mixture is agglomerated to form intermediate agglomerates. The intermediate agglomerates exiting the Lodige KM mixer are passed through a sieve and intermediate agglomerates having a particle size greater than 5 millimeters are removed from the remainder of the intermediate agglomerates and recycled back to the Lodige CB mixer. The remaining portion of the intermediate agglomerates is transferred into a fluid bed dryer and then a fluid bed cooler. Intermediate agglomerates having a very small particle size (i.e. the fines having a particle size of less than 250 micrometers) are elutriated by the fluid bed exhaust system where they are collected and recycled back to the CB mixer. The remaining portion of the intermediate agglomerates exiting the fluid bed cooler is passed through a sieve and intermediate agglomerates having a particle size greater than 850 micrometers are removed from the remainder of the intermediate agglomerates, passed through a grinder where they are ground into particles having a smaller particle size and are then recycled back to the fluid bed dryer. The remaining portion of the intermediate agglomerates is collected and is suitable for use in the present invention; this remaining portion is the anionic surfactant agglomerates having the above described formulation (example 1.1).

1.3. Solid Laundry Detergent Composition

| Ingredient | Amount |
|---|---|
| Anionic surfactant agglomerate | 78 wt % |
| (described in example 1.1) | |
| Sodium bicarbonate | 19.3 wt % |
| Sodium sulphite | 0.5 wt % |
| Polyvinylpyrrolidone | 0.2 wt % |
| Hydrophobic silica | 0.5 wt % |
| Dry-add perfume | 0.5 wt % |
| Spray-on perfume | 0.2 wt % |
| Orange Dye | 0.8 wt % |

1.4 Finished Product Process

The above described anionic surfactant agglomerate (described in example 1.1) is mixed with solid material comprising sodium bicarbonate, sodium sulphite, polyvinylpyrrolidone, hydrophobic silica and dry-add perfume. The sprayed-on perfume and orange dye (in liquid form) are then sprayed on to this mixture to obtain a solid laundry detergent composition described in more detail above (example 1.3).

### Example 2

As example 1, except that some of the sodium sulphate is added into the Lodige KM mixer, in addition to the Lodige CB mixer.

### Example 3

As in example 1, except that the agglomerate comprises 37 wt % sodium sulphate (instead of 40 wt %) and 3 wt % zeolite A. The zeolite A is added into the fluid bed dryer in fine particulate form having a weight average particle size of from 2 micrometers to 25 micrometers.

### Example 4

As in example 1, except that the solid laundry detergent composition comprises 76 wt % anionic surfactant agglomerate (described in example 1.1) and 2 wt % zeolite A. The zeolite A is in fine particulate form having an average particle size of from 2 micrometers to 25 micrometers and is added to the anionic surfactant agglomerate in the finished product process along with the other dry-added materials such as the sodium bicarbonate.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A solid laundry detergent composition comprising:
(a) from 0.1 wt % to 5 wt %, by weight of the composition, of branched alkyl alkoxylated sulphate surfactant having an average degree of alkoxylation of from 1 to 7;
(b) from 0.1 wt % to 5 wt % by weight of the composition, of linear alkyl alkoxylated sulphate surfactant having an average degree of alkoxylation of from 1 to 7;
(c) from 0.1 wt % to 35 wt %, by weight of the composition, of linear alkyl benzene sulphonate surfactant;
(d) from 0 wt % to 5 wt %, by weight of the composition, of zeolite builder;
(e) from 0 wt % to 5 wt %, by weight of the composition, of phosphate builder; and
(f) optionally, adjunct components;
wherein the weight ratio of the branched alkyl alkoxylated sulphate surfactant to the linear alkyl alkoxylated sulphate surfactant is in the range of from 0.2:1 to 4:1.

2. A composition according to claim 1, wherein the branched alkyl alkoxylated sulphate surfactant has an alkyl chain length distribution such that:
(a) less than 1.2 wt % by weight of the alkyl chains, are alkyl chains having a chain length of less than 12 carbon atoms;
(b) from 5 wt % to 20 wt % by weight of the alkyl chains, are alkyl chains having a chain length of 12 carbon atoms;
(c) from 40 wt % to 50 wt % by weight of the alkyl chains, are alkyl chains having a chain length of 14 carbon atoms; and
(d) less than 4 wt % by weight of the alkyl chains, are alkyl chains having a chain length of greater than 15 carbon atoms.

3. A composition according to claim 1, wherein the branched alkyl alkoxylated sulphate surfactant is a C₁₂-C₁₅ alkyl ethoxylated sulphate surfactant that is branched with a C₁-C₃ alkyl moiety.

4. A composition according to claim 1, wherein the branched alkyl alkoxylated sulphate surfactant is predominantly branched on the 2-position.

5. A composition according to claim 1, wherein the linear alkyl alkoxylated sulphate surfactant has an alkyl chain length distribution such that:
(a) less than 1.2 wt % by weight of the alkyl chains, are alkyl chains having a chain length of less than 12 carbon atoms;
(b) from 5 wt % to 20 wt % by weight of the alkyl chains, are alkyl chains having a chain length of 12 carbon atoms;
(c) from 40 wt % to 50 wt % by weight of the alkyl chains, are alkyl chains having a chain length of 14 carbon atoms; and
(d) less than 4 wt % by weight of the alkyl chains, are alkyl chains having a chain length of greater than 15 carbon atoms.

6. A composition according to claim 1, wherein the linear alkyl alkoxylated sulphate surfactant is a linear C₁₂-C₁₅ alkyl ethoxylated sulphate surfactant.

7. A composition according to claim 1, wherein the composition is substantially free from zeolite builder and phosphate builder.

8. A composition according to claim 1, wherein the weight ratio of the branched alkyl alkoxylated sulphate surfactant to the linear alkyl alkoxylated sulphate surfactant is in the range of from 1:1 to 1.5:1.

9. A composition according to claim 1, wherein the branched alkyl alkoxylated sulphate surfactant, the linear alkyl alkoxylated sulphate surfactant and the linear alkyl benzene sulphonate surfactant are in the form of a co-particulate admix.

10. A composition according to claim 1, wherein the composition comprises a source of carbonate and sodium sulphate, and wherein the weight ratio of the source of carbonate to sodium sulphate is in the range of from 0.1:1 to 1:1.

11. A composition according to claim 1, wherein the weight ratio of the linear alkyl benzene sulphonate to the total amount of linear and branched alkyl alkoxylated sulphate surfactants is in the range of from 1:1 to 20:1.
